(19) United States
(12) Patent Application Publication
(10) Pub. No.: US 2012/0055072 A1
(43) Pub. Date: Mar. 8, 2012

(54) Directional guide for fishing lures

(76) Inventor: Sammy D. Rankin, Hughes Springs, TX (US)

(21) Appl. No.: 12/807,548

(22) Filed: Sep. 8, 2010

(51) Int. Cl. A01K 91/06

(52) U.S. Cl. 43/43.13

(57) ABSTRACT

A directional guide for a fishing lure includes a guide body having a first guide body section and a second guide body section generally complementary in size and shape to the first guide body section, the first guide body section and the second guide body section adapted for attachment to a fishing line; and at least one beveled guide body end on the guide body.

### FIELD

The disclosure generally relates to fishing lures. More particularly, the disclosure relates to a directional guide which is placed on a fishing line between a fishing rod from which the fishing line extends and a trailing fishing lure to impart a curved or sideways trajectory to the fishing lure during lure retrieval.

### BACKGROUND

A variety of fishing lures are known in the art for attracting game fish or other aquatic creatures to a hook or hooks on a fishing line. Artificial fishing lures commonly include a hard or soft plastic lure body which is shaped and colored to resemble the appearance of a worm, crawfish, shad or other aquatic creature and may be fitted with one or multiple fishing hooks. The lure body is typically tied on the end of the fishing line, which may be wound on a crank-operated reel provided on a fishing rod. Accordingly, the fishing rod is typically used to cast the artificial fishing lure into a lake or other water body after which the reel is operated to retrieve the fishing lure through or on top of the water body to attract fish to the lure.

The effectiveness of a fishing lure in attracting game fish may depend in large part on how closely the fishing lure resembles natural prey which are normally pursued by the fish. Accordingly, fishing lure manufacturers expend much effort to fabricate fishing lures which resemble as closely as possible the appearances, sounds and swim characteristics of the natural prey of game fish. In a typical lure retrieval scenario, the fishing lure travels in a straight line from the casting point back toward the fishing rod as the fishing line is wound on the reel. In reality, however, natural prey which is normally pursued by fish in the water body may swim along a curved path. Therefore, conventional methods and techniques which are used to rig a fishing lure on a fishing line may not result in lifelike movements of the fishing lure which would otherwise attract attention to the lure and induce the fish to strike the lure during lure retrieval.

A common result of the straight-line retrieval motion which characterizes conventional fishing lure rigging methods and techniques is the tendency of the fishing lure to become inadvertently snagged on structures such as stumps and pier pilings in a water body during lure retrieval. Under circumstances in which the snagged fishing lure cannot be pulled free from the structure, cutting of the fishing line and loss of the fishing lure may be necessary.

Therefore, a directional guide which is placed on a fishing line between a fishing rod from which the fishing line extends and a trailing fishing lure on the fishing line to impart a curved or sideways trajectory to the fishing lure during lure retrieval is needed. The directional guide imparts a lifelike curved motion or path to the fishing lure to attract the attention of game fish to the lure and enhance the likelihood that the fish will strike the lure. The directional guide may also block contact between the fishing lure and structures such as stumps and pier pilings in the water body to prevent the fishing lure from becoming inadvertently snagged on the structures during retrieval of the fishing lure.

### SUMMARY

The disclosure is generally directed to a directional guide for a fishing lure which is placed on a fishing line between a fishing rod from which the fishing line extends and a trailing fishing lure to impart a curved or sideways trajectory to the fishing lure during lure retrieval. An illustrative embodiment of the directional guide includes a guide body having a first guide body section and a second guide body section generally complementary in size and shape to the first guide body section, the first guide body section and the second guide body section adapted for attachment to a fishing line; and at least one beveled guide body end on the guide body.

In some embodiments, the directional guide for a fishing lure may include a guide body adapted for attachment to a fishing line and having a first guide body section, a second guide body section generally complementary in size and shape to the first guide body section and a fishing line gap between the first guide body section and the second guide body section; and at least one structurally unobstructed beveled guide body end on the guide body.

The disclosure is further generally directed to a fishing lure assembly. An illustrative embodiment of the fishing lure assembly includes a fishing line, a directional guide having a guide body carried by the fishing line and at least one beveled guide body end on the guide body and a fishing lure carried by the fishing line in trailing relationship to the directional guide.

### BRIEF DESCRIPTION OF THE DRAWINGS

The disclosure will now be made, by way of example, with reference to the accompanying drawings, in which:

FIG. 1 is a side view of an illustrative embodiment of the directional guide for fishing lures, attached to a fishing line between a fishing rod and a trailing fishing lure and floating on a water body in exemplary application of the guide;

FIG. 2 is a top perspective view of an illustrative embodiment of the directional guide for fishing lures, with the guide provided on a fishing line (partially in section) and exerting a curved or sideways pulling action on the fishing lure (illustrated in phantom) as the lure is retrieved;

FIG. 3 is a side view, partially in section, of an illustrative embodiment of the directional guide for fishing lures, more particularly illustrating a pair of fishing line retention springs provided in a guide body of the guide to retain the guide on a fishing line;

FIG. 4 is a top perspective view of the directional guide for fishing lures, with the fishing line extending through a fishing line gap between a pair of adjacent guide body sections of the guide body;

FIG. 5 is an enlarged sectional view of a fishing line retention spring seated in opposing spring cavities in the guide body sections of the guide body, with the fishing line retained between spring coils of the fishing line retention spring;

FIG. 5A is an enlarged sectional view of a weight seated in a weight cavity provided in a guide body section of the guide body;

FIG. 6 is a side view of an illustrative embodiment of the directional guide for fishing lures, with the fishing line extending at an angle from respective ends of the guide body;

FIG. 7 is an interior view of an illustrative embodiment of the directional guide for fishing lures, more particularly illustrating a pair of fishing line retention springs between the guide body sections of the guide body and a fishing line retained by the fishing line retention springs according to an exemplary technique for retaining the guide on the fishing line;

FIG. 8 is an interior view of an alternative illustrative embodiment of the directional guide for fishing lures, more particularly illustrating a single fishing line retention spring between the guide body sections of the guide body and a fishing line retained by the fishing line retention spring according to an exemplary technique for retaining the guide on the fishing line;

FIG. 9 is an interior view of another alternative illustrative embodiment of the directional guide for fishing lures, more particularly illustrating an exemplary technique for clamping the guide on the fishing line by securing the guide body sections together using elastomeric glue;

FIG. 10 is an interior view of still another alternative illustrative embodiment of the directional guide for fishing lures, more particularly illustrating an exemplary technique for clamping the guide on the fishing line by securing the guide body sections together using magnets;

FIG. 11A is a top perspective view of an illustrative embodiment of the directional guide for fishing lures, more particularly illustrating initial partial insertion of the fishing line in the fishing line gap between the guide body sections of the guide body in retention of the guide on the fishing line;

FIG. 11B is a top perspective view of an illustrative embodiment of the directional guide for fishing lures, with the fishing line completely inserted in the fishing line gap and retained by the fishing line retention springs (illustrated in phantom) and extending from opposite ends of the guide body;

FIG. 12A is a top view of the directional guide for fishing lures attached to a fishing line (partially in section) ahead of a trailing fishing lure, more particularly illustrating a zigzagged travel path of the guide around successive structures (illustrated in section) in a water body during retrieval of the fishing lure;

FIG. 12B-1 is a top view of the directional guide for fishing lures attached to a fishing line ahead of a trailing fishing lure, more particularly illustrating initial contact of the guide with the side of the structure during retrieval of the fishing lure;

FIG. 12B-2 is a top view of the directional guide for fishing lures illustrated in FIG. 12B-1 as the guide partially rotates and an end surface on the guide makes substantially full contact with the side of the structure and the guide begins to lead the fishing lure away from the structure during continued retrieval of the fishing lure;

FIG. 12B-3 is a top view of the directional guide for fishing lures illustrated in FIGS. 12B-1 and 12B-2 as the guide continues to rotate and the end surface on the guide slides around a portion of the structure and leads the fishing lure around the structure during continued retrieval of the fishing lure;

FIG. 12B-4 is a top view of the directional guide for fishing lures illustrated in FIGS. 12B-3 as the edge of the guide contacts the side of the structure during continued retrieval of the fishing lure;

FIG. 12B-5 is a top view of the directional guide for fishing lures illustrated in FIGS. 12B-3 as the long edge of the guide slides along the side of the structure and the guide clears the structure and continues to lead the fishing lure around from the structure during continued retrieval of the fishing lure; and

FIG. 13 is a top view of a boat (illustrated in phantom), with fishing lines deployed on opposite sides of the boat and directional guides for fishing lures on the fishing lines directing the fishing lures on the respective fishing lines away from the boat.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

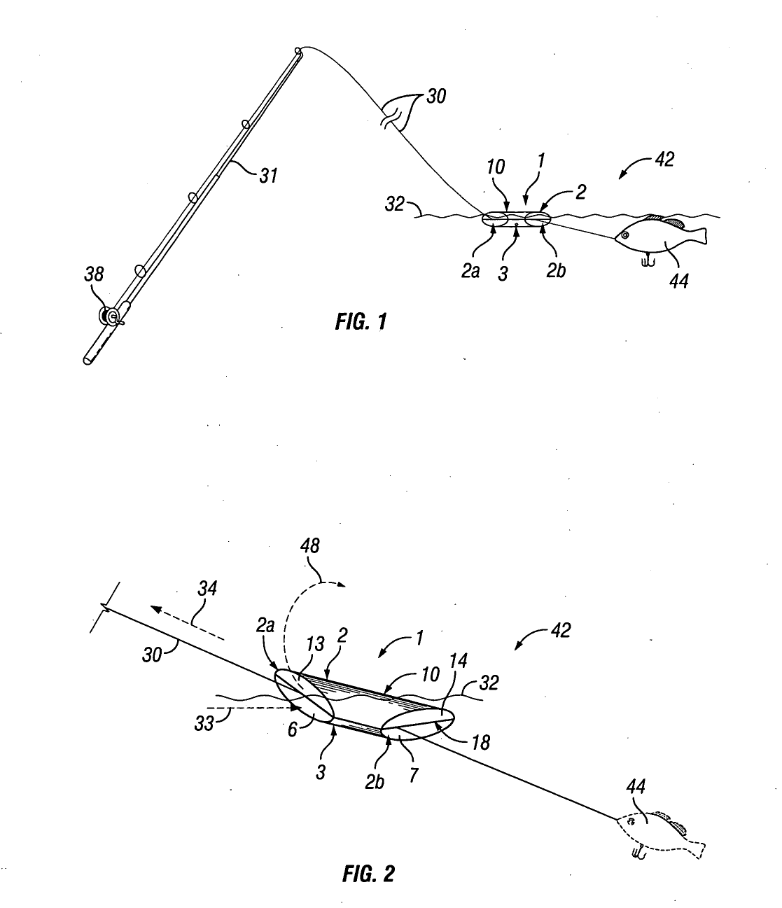

Referring initially to FIGS. 1 and 2 of the drawings, an illustrative embodiment of the directional guide for fishing lures, hereinafter guide, is generally indicated by reference numeral 1. As will be hereinafter further described, the guide 1 may be part of a fishing lure assembly 42 in which the guide 1 is adapted for attachment to a fishing line 30 that may be wound on a reel 38 provided on a fishing rod 31. A fishing lure 44 may be tied to the end of the fishing line 30 which extends from the fishing rod 31 in trailing relationship to the guide 1. The guide 1 has a guide body 2 which may include a first guide body end 2a and a second guide body end 2b, at least one of which is beveled, and may be attached to the fishing line 30 between the fishing rod 31 and the fishing lure 44 typically in a manner which will be hereinafter described. The bevel of one or both of the first guide body end 2a and the second guide body end 2b may be any desired angle. In some embodiments, the bevel angle may be from about 60° to about 70° and preferably about 63°. Upon casting of the fishing lure 44 into a water body 32 in application of the guide 1, the guide 1 may float on the water body 2. As the fishing lure 44 is subsequently retrieved through the water body 32, the force 33 (FIG. 2) of the water in the water body 32 is applied against whichever of the beveled first guide body end 2a and second guide body end 2b of the forward-moving guide 1 faces the fishing rod 31, causing the guide 1 to travel along a curved or sideways guide travel path 48 (FIG. 2) relative to the fishing line axis 34 of the fishing line 30. Each of the first guide body end 2a and the second guide body end 2b may have a smooth and structurally unobstructed surface which facilitates unimpeded flow of water over the surface. Additionally, the smooth and structurally unobstructed surface of each of the first guide body end 2a and the second guide body end 2b prevents the guide body 2 from becoming inadvertently snagged on stumps and the like. The guide 1 pulls the fishing lure 44 in a curved sideways motion or path relative to the fishing line axis 34, imparting a lifelike swimming action to the fishing lure 44 which attracts the attention of game fish (not illustrated) in the water body 32 to the fishing lure 44 and increases the likelihood that the game fish will strike the fishing lure 44. Additionally, the guide 1 may substantially prevent the fishing lure 44 from becoming inadvertently snagged on various structures (not illustrated) such as stumps and pier pilings, for example and without limitation, in the water body 32 during retrieval of the fishing lure 44, as will be hereinafter described.

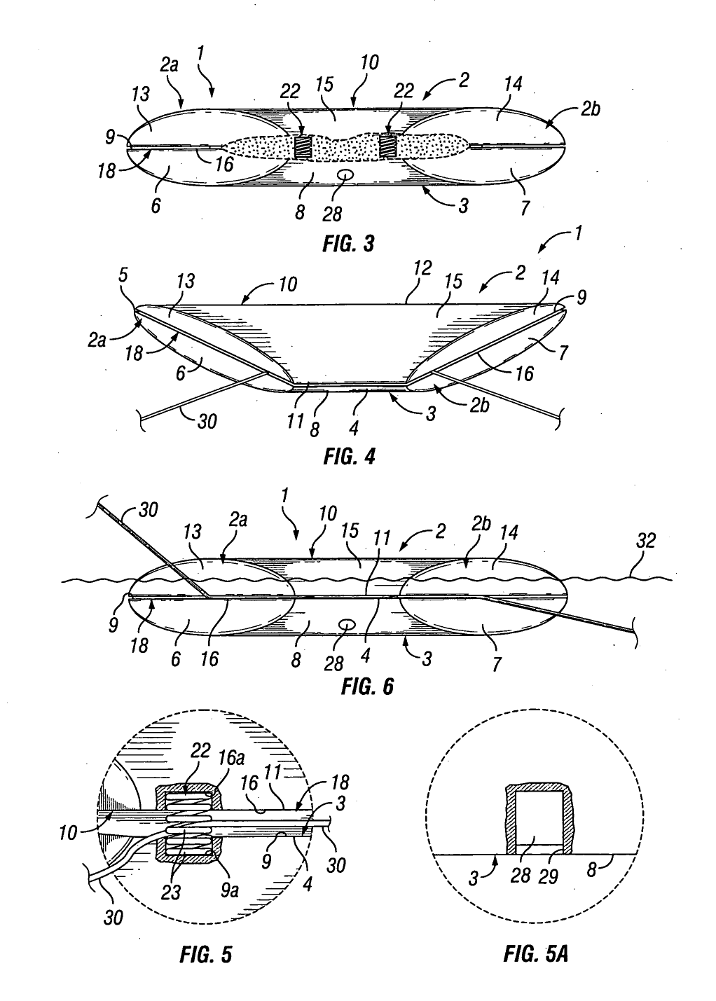

Referring next to FIGS. 3-7, 11A and 11B of the drawings, the guide body 2 of the guide 1 may have a generally cylindrical shape. The guide body 2 may be wood, plastic or other waterproof buoyant material. The first guide body end 2a and the second guide body end 2b are opposite each other on the guide body 2. At least one of the first guide body end 2a and the second guide body end 2b of the guide body 2 is beveled. In some embodiments, both the first guide body end 2a and the second guide body end 2b are beveled, as illustrated. The guide body 2 of the guide 1 is adapted for attachment to the fishing line 30 (FIG. 1) typically in a manner which will be hereinafter described.

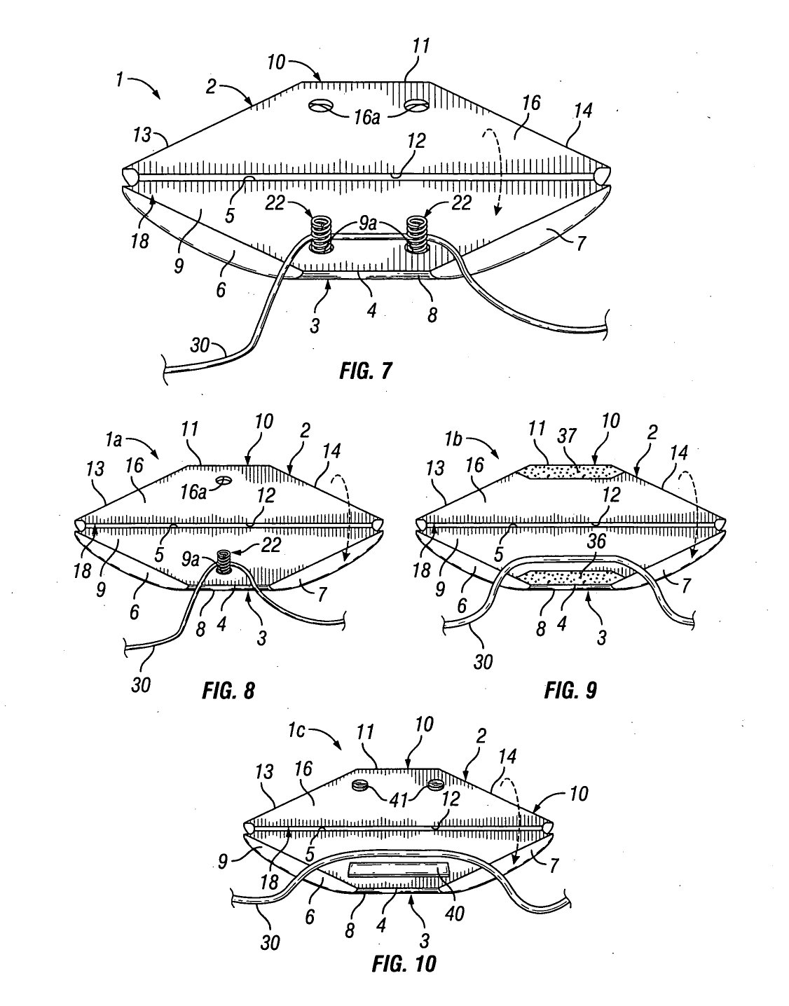

In some embodiments, the guide body 2 of the guide 1 may have a first guide body section 3 and a matching or complementary second guide body section 10, each of which may have a generally half-cylindrical shape. The first guide body section 3 of the guide body 2 has a first end surface 6 and a second end surface 7 which is opposite the first end surface 6. At least one of the first end surface 6 and the second end surface 7 is beveled. In some embodiments, both of the first end surface 6 and the second end surface 7 are beveled, as illustrated. As illustrated in FIG. 4, a short edge 4 may extend between the first end surface 6 and the second end surface 7 of the first guide body section 3. A long edge 5 may extend between the first end surface 6 and the second end surface 7 in generally parallel, spaced-apart relationship with respect to the short edge 4 of the first guide body section 3. On one side of the of the first guide body section 3, a generally convex exterior surface 8 may extend between the short edge 4 and the long edge 5 and between the first end surface 6 and the second end surface 7. On the other side of the of the first guide body section 3, a generally flat or planar interior surface 9 (FIG. 7) may extend between the short edge 4 and the long edge 5 and between the first end surface 6 and the second end surface 7.

The second guide body section 10 of the guide body 2 may have a size and shape which are complementary to the size and shape, respectively, of the first guide body section 3. Accordingly, the second guide body section 10 has a first end surface 13 and a second end surface 14 which is opposite the first end surface 13. At least one of the first end surface 13 and the second end surface 14 is beveled. In some embodiments, both of the first end surface 13 and the second end surface 14 are beveled, as illustrated. A short edge 11 may extend between the first end surface 13 and the second end surface 14 of the second guide body section 10. A long edge 12 may extend between the first end surface 13 and the second end surface 14 in generally parallel, spaced-apart relationship with respect to the short edge 11 of the second guide body section 10. On one side of the second guide body section 10, a convex exterior surface 15 may extend between the short edge 11 and the long edge 12 and between the first end surface 13 and the second end surface 14. On the other side of the second guide body section 10, a flat or planar interior surface 16 (FIG. 7) may extend between the short edge 11 and the long edge 12 and between the first end surface 13 and the second end surface 14.

The guide body 2 may be assembled by attachment of the second guide body section 10 to the first guide body section 3 typically in a manner which will be hereinafter described. In the assembled guide body 2, the planar interior surface 16 of the second guide body section 10 may be disposed in generally parallel, adjacent relationship with respect to the planar interior surface 9 of the first guide body section 3. The short edge 11 of the second guide body section 10 extends parallel and adjacent to the short edge 4 of the first guide body section 3. The long edge 12 of the second guide body section 10 extends parallel and adjacent to the long edge 5 of the first guide body section 3. The first end surface 13 of the second guide body section 10 complements and extends adjacent to the first end surface 6 of the first guide body section 3. Likewise, the second end surface 14 of the second guide body section 10 complements and extends adjacent to the second end surface 7 of the first guide body section 3. Accordingly, the first guide body end 2a of the guide body 2 is defined by the first end surface 6 of the first guide body section 3 and the first end surface 13 of the second guide body section 10. Likewise, the second guide body end 2b of the guide body 2 is defined by the second end surface 7 of the first guide body section 3 and the second end surface 14 of the second guide body section 10.

The second guide body section 10 may be attached to the first guide body section 3 according to any suitable technique which is known by those skilled in the art. In some embodiments, the fishing line 30 may be attached to the guide body 2 using screw eyes (not illustrated) in the conventional manner. As illustrated in FIGS. 5 and 7, in some embodiments a pair of spaced-apart fishing line retention springs 22, each having spring coils 23 (FIG. 5), may be seated in a first pair of spring cavities 9a, respectively, provided in the interior surface 9 of the first guide body section 3 and in a second pair of spring cavities 16a, respectively, provided in the interior surface 16 of the second guide body section 10. Each fishing line retention spring 22 may be secured in each corresponding pair of spring cavities 9a, 16a pair using glue, molding and/or other suitable attachment technique. As illustrated in FIGS. 3-6, a fishing line gap 18 may be defined by and between the interior surface 9 of the first guide body section 3 and the interior surface 16 of the second guide body section 10 for purposes which will be hereinafter described. As illustrated in FIG. 7, the first pair of spring cavities 9a may be provided in the interior surface 9 in general proximity to the short edge 4 of the first guide body section 3. Likewise, the second pair of spring cavities 16a may be provided in the interior surface 16 in general proximity to the short edge 11 of the second guide body section 10.

As illustrated in FIGS. 3, 5A and 6, at least one weight 28 may be provided in at least one of the first guide body section 3 and the second guide body section 10. As illustrated in FIG. 5A, each weight 28 may be contained in a weight cavity 29. In some embodiments, the weight cavity 29 may extend into the exterior surface 8 of the first guide body section 3. In other embodiments, the weight cavity 29 may extend into the interior surface 9 of the first guide body section 3; the interior surface 16 of the second guide body section 2; or the exterior surface 15 of the second guide body section 10, or may be provided in any other suitable location in the guide body 2.

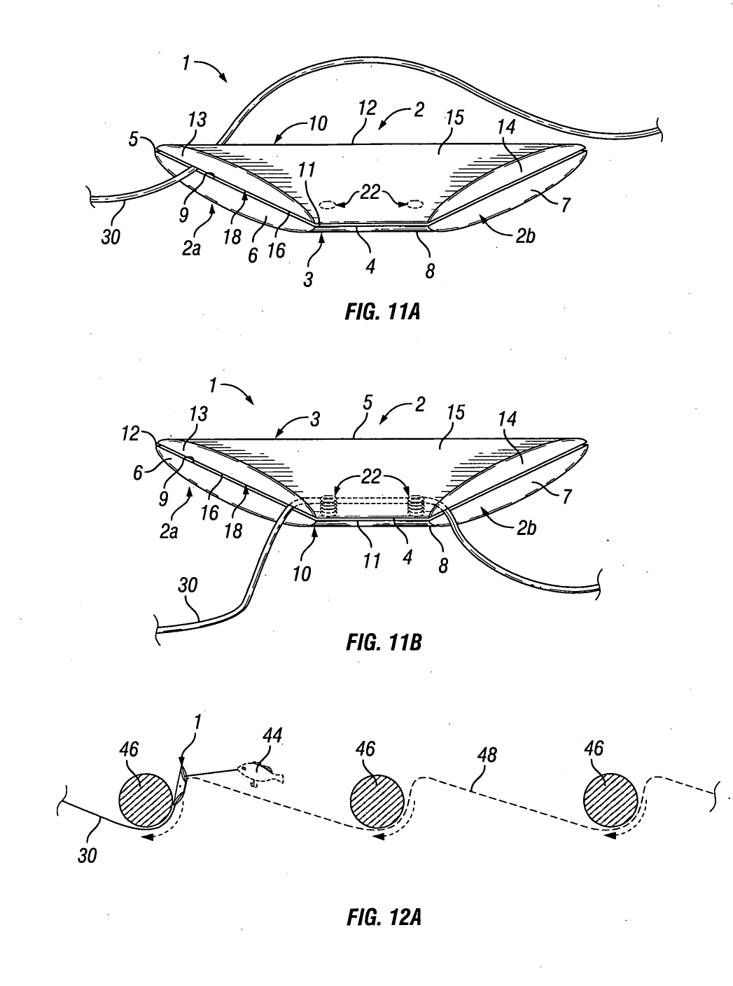

The guide body 2 of the guide 1 may be quickly and detachably retained on the fishing line 30 as follows. As illustrated in FIG. 11A, the fishing line 30 is initially inserted into the fishing line gap 18 between the long edge 5 of the first guide body section 3 and the long edge 12 of the second guide body section 10. As illustrated in FIG. 11B, the fishing line 30 is next pulled through the fishing line gap 18 toward and then against the fishing line retention springs 22. Force is applied to the fishing line 30 until the fishing line 30 inserts between a pair of spring coils 23 of each fishing line retention spring 22, as illustrated in FIG. 5. Accordingly, the fishing line 30 is compressed and held in place between the spring coils 23 of each fishing line retention spring 22 such that the fishing line 30 is secured and immobilized in the fishing line gap 18 between the first guide body section 3 and the second guide body section 10. As illustrated in FIG. 4, the fishing line 30 may extend from the first guide body end 2a at about one-fourth to about one-third the distance from the short edges 4 and 11 to the long edges 5 and 12 of the first guide body section 2 and the second guide body section 10, respectively. Likewise, the fishing line 30 may extend from the second guide body end 2b at about one-fourth to about one-third the distance from the short edges 4 and 11 to the long edges 5 and 12 of the first guide body section 2 and the second guide body section 10, respectively.

Referring again to FIGS. 1 and 2 of the drawings, in exemplary application of the guide 1, the guide body 2 is retained on a fishing line 30 which extends from a fishing rod 31. The guide body 2 is disposed between the end of the fishing rod 31 and a fishing lure 44 which is tied on the end of the fishing line 30. The fishing line 30 may be wound on a reel 38 provided on the fishing rod 31. The guide body 2 of the guide 1 may be quickly, easily and detachably attached to the fishing line 30 by inserting the fishing line 30 in the fishing line gap 18 (FIG. 2) until the fishing line 30 is inserted between and retained by the spring coils 23 in each of the fishing line retention springs 22, as was heretofore described with respect to FIGS. 5, 11A and 11B, and extends from the first guide body end 2a and the second guide body end 2b of the guide body 2, as illustrated in FIG. 4. It will be appreciated by those skilled in the art that the guide body 2 of the guide 1 may be quickly and easily placed on the fishing line 30 at any position relative to the fishing lure 44 as was heretofore described.

After the guide 1 is attached to the fishing line 30 typically as was heretofore described, the fishing lure 44 and the guide 1 are cast on the fishing line 30 into a water body 32 using the fishing rod 31 and reel 38. As illustrated in FIG. 6, in some embodiments of the guide 1, the buoyancy of the guide body 2 and positioning of the weight 28 in the guide body 2 may be selected such that the lower three-fourths of the guide body 2 is submerged beneath the surface of the water body 32 and the upper one-fourth of the guide body 2 extends above the surface of the water body 32. The fishing lure 44 and guide 1 are then retrieved in the water body 32 by operation of the reel 38, typically in the conventional manner. As the fishing line 30 is wound on the reel 38 along the fishing line axis 34 (FIG. 2), the fishing line 30 pulls the guide 1 and the fishing lure 44 in the water body 32. The force 33 (FIG. 2) of the water in the water body 32 as the guide 1 moves through the water body 32 is exerted against the beveled first guide body end 2a of the guide body 2. Therefore, the water force 33 pushes the guide 1 along a curved or sideways guide travel path 48 relative to the fishing line axis 34. The guide 1 pulls the trailing fishing lure 44 along the curved or sideways guide travel path 48. The speed of travel of the guide 1 and the fishing lure 44 along the curved or sideways guide travel path 48 may correspond to the speed at which the fishing line 30 is wound on the reel 38. The curved or sideways movement of the fishing lure 44 along the guide travel path 48 may attract the attention of game fish (not illustrated) in the water body 32 to the fishing lure 44 and increase the likelihood of the game fish striking the fishing lure 44. The guide 1 may be selectively detached from the fishing line 30 by pulling the fishing line 30 from between the spring coils 23 (FIG. 5) of each fishing line retention spring 22 and removing the fishing line 30 from the fishing line gap 18.

It will be appreciated by those skilled in the art that the direction in which the guide 1 and the fishing lure 44 travel along the guide travel path 48 relative to the fishing line axis 34 may be selected depending on which of the first guide body end 2a and the second guide body end 2b faces the fishing rod 31. In the example illustrated in FIG. 2, the first guide body end 2a of the guide body 2 faces the fishing rod 31 (FIG. 1) whereas the second guide body end 2b faces the fishing lure 44; therefore, the orientation of the beveled first guide body end 2a relative to the fishing line axis 34 is such that the water force 33 pushes the guide 1 and the fishing lure 44 along a guide travel path 48 which extends to the right of the fishing line axis 34 in FIG. 2. In applications in which the orientation of the guide 1 on the fishing line 30 is reversed (such that the second guide body end 2b faces the fishing rod 31 and the first guide body end 2a faces the fishing lure 44), the orientation of the beveled second guide body end 2b relative to the fishing line axis 34 is such that the water force 33 pushes the guide 1 and the fishing lure 44 along a guide travel path 48 which extends to the left of the fishing line axis 34 in FIG. 2.

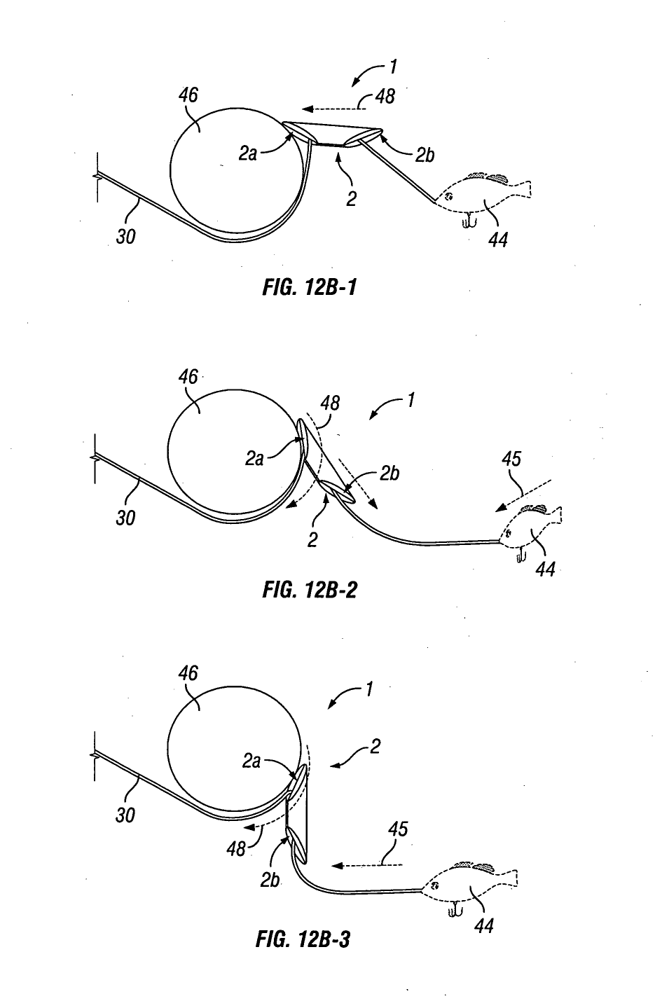

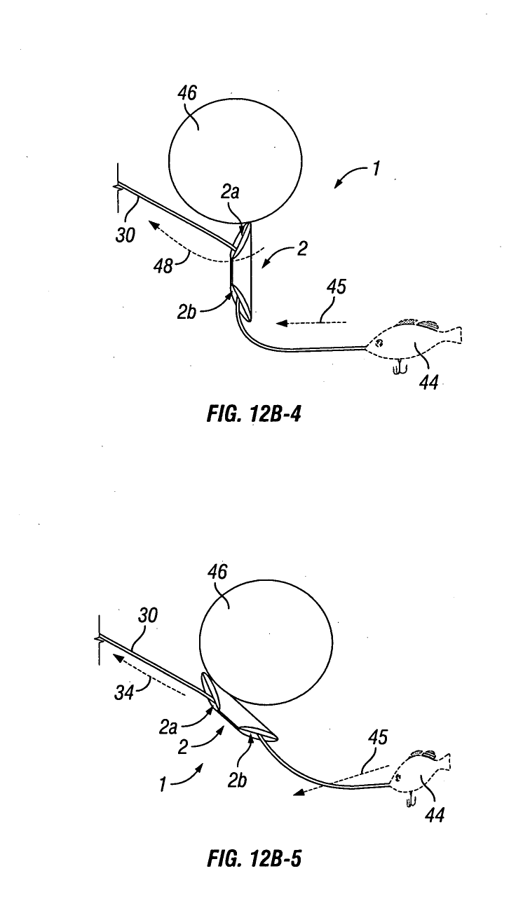

Referring next to FIGS. 12A-12B-5 of the drawings, it will be appreciated by those skilled in the art that the guide 1 may prevent the fishing lure 44 from becoming inadvertently snagged on structures 46 such as stumps and pier pilings, for example and without limitation, as the fishing lure 44 is retrieved through the water body 32. As illustrated in FIG. 12B-1, as the guide 1 approaches a structure 46 in the water body 32 during retrieval, the beveled first guide body end 2a initially contacts the side of the structure 46 as the fishing lure 44 trails behind the guide 1 on the fishing line 30. As illustrated in FIGS. 12B-2 and 12B-3, as retrieval of the fishing lure 44 through the water body 32 continues, the first guide body end 2a continues to slide along the side of the structure 46 along the guide travel path 48. Simultaneously, the guide 1 pulls the fishing lure 44 along a fishing lure travel path 45 which is parallel to the structure 46. As illustrated in FIGS. 12B-4 and 12B-5, continued retrieval of the guide 1 and the fishing lure 44 causes the guide 1 to continue sliding along the side of the structure 46 until the guide 1 clears the structure 46 and the fishing lure 44 travels along the fishing lure travel path 45 around the structure 46. As illustrated in FIG. 12A, in the foregoing manner, the guide 1 may repeatedly block or shield the fishing lure 44 from contact with multiple successive structures 46 such that the fishing lure 44 does not contact and become snagged on any of the structures 46. The guide 1 additionally directs the fishing lure 44 beneath structures such as limbs and piers, for example and without limitation,

Referring next to FIG. 8 of the drawings, an alternative illustrative embodiment of the directional guide for fishing lures is generally indicated by reference numeral 1a. The guide 1a may be similar in design to the guide 1 which was heretofore described with respect to FIGS. 1-7 except a single fishing line retention spring 22 may extend between the first guide body section 3 and the second guide body section 10 of the guide body 2. The guide 1a may be retained on the fishing line 30 by inserting the fishing line 30 into the fishing line gap 18 between the first guide body section 3 and the second guide body section 10 until the fishing line 30 becomes inserted and retained between the spring coils 23 (FIG. 5) of the fishing line retention spring 22, as was heretofore described. The guide 1a may be selectively detached from the fishing line 30 by pulling the fishing line 30 from between the spring coils 23 of the fishing line retention spring 22 and removing the fishing line 30 from the fishing line gap 18.

Referring next to FIG. 9 of the drawings, another alternative illustrative embodiment of the directional guide for fishing lures is generally indicated by reference numeral 1b. The guide 1b may be similar in design to the guide 1 which was heretofore described with respect to FIGS. 1-7 except a first elastomeric glue strip 36 may be provided on the interior surface 9 of the first guide body section 3 and a second elastomeric glue strip 37 may be provided on the interior surface 16 of the second guide body section 10. The first elastomeric glue strip 36 may be provided along the short edge 4 or in any other suitable location on the interior surface 9 of the first guide body section 3. The second elastomeric glue strip 36 may be provided along the short edge 11 or in any other suitable location on the interior surface 16 of the second guide body section 10. The guide 1b may be retained on the fishing line 30 by placing the fishing line 30 between the first guide body section 3 and the second guide body section 10 and then pressing the first guide body section 3 and the second guide body section 10 together such that the first elastomeric glue strip 36 and the second elastomeric glue strip 37 secure the first guide body section 3 and the second guide body section 10 together. This retains the fishing line 30 between the interior surface 9 of the first guide body section 3 and the interior surface 16 of the second guide body section 10. The guide 1b may be selectively detached from the fishing line 30 by pulling the first guide body section 3 and the second guide body section 10 apart at the first elastomeric glue strip 36 and the second elastomeric glue strip 37 and removing the fishing line 30 from between the first guide body section 3 and the second guide body section 10.

Referring next to FIG. 10 of the drawings, still another alternative illustrative embodiment of the directional guide for fishing lures is generally indicated by reference numeral 1c. The guide 1c may be similar in design to the guide 1b which was heretofore described with respect to FIG. 9 except a first magnet 40 may be provided on the interior surface 9 of the first guide body section 3 and a second magnet 41 may be provided on the interior surface 16 of the second guide body section 10. In some embodiments the first magnet 40 may be a bar magnet and the second magnet 41 may include at least one disk magnet, as illustrated. The first magnet 40 may be provided along the short edge 4 or in any other suitable location on the interior surface 9 of the first guide body section 3. The second magnet 41 may be provided along the short edge 11 or in any other suitable location on the interior surface 16 of the second guide body section 10. The guide 1c may be retained on the fishing line 30 by placing the fishing line 30 between the first guide body section 3 and the second guide body section 10 and then engaging the first magnet 40 and the second magnet 41 such that the first magnet 40 and the second magnet 41 secure the first guide body section 3 and the second guide body section 10 together. The fishing line 30 is retained between the interior surface 9 of the first guide body section 3 and the interior surface 16 of the second guide body section 10. The guide 1c may be selectively detached from the fishing line 30 by pulling the first guide body section 3 and the second guide body section 10 apart at the first magnet 40 and the second magnet 41 and removing the fishing line 30 from between the first guide body section 3 and the second guide body section 10.

In yet another alternative illustrative embodiment of the directional guide for fishing lures (not illustrated), the lure body is shaped in the configuration of a cylindrical cork which may include complementary first and second guide body sections. The guide body sections may be fitted with any of various attachment techniques to facilitate attachment of the guide body sections to each other. These may include, for example and without limitation, the fishing line retention spring or springs 22 (FIGS. 7 and 8); the first elastomeric glue strip 36 and the second elastomeric glue strip 37 (FIG. 9); the magnets 40, 41 (FIG. 10); the eye hooks 50 (FIG. 10A); or the fishing line retention rod 70 removably fitted in the rod cavity 25 (FIG. 10B). The guide body ends of the guide body may be flat rather than truncated. Application of the directional guide for fishing lures may be as was heretofore described with respect to the directional guide for fishing lures 1 in FIGS. 1-7.

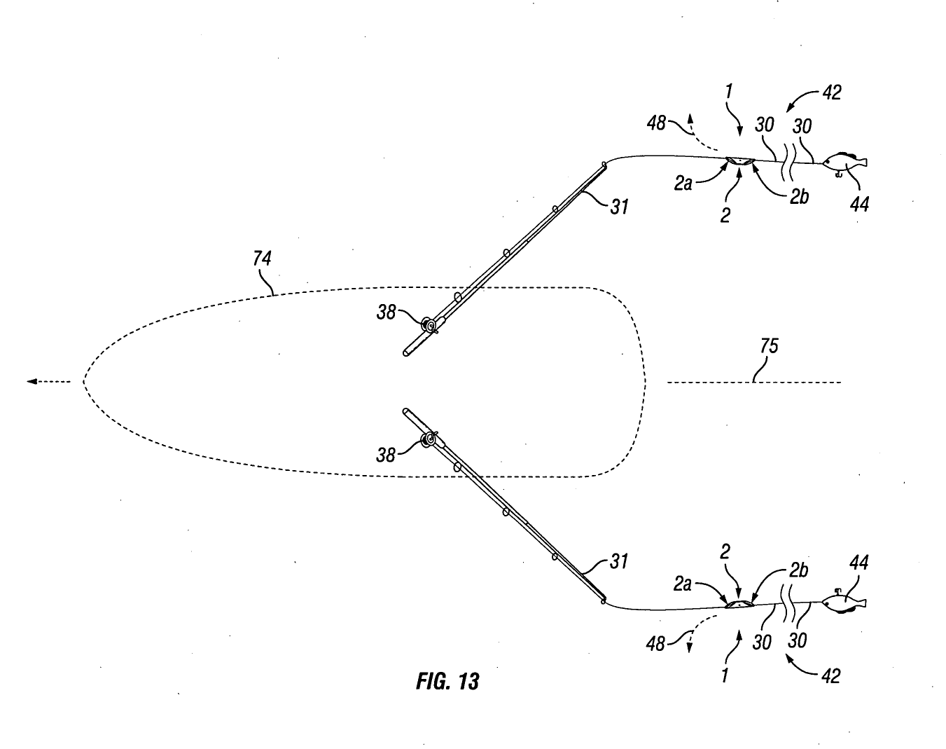

Referring next to FIG. 13 of the drawings, it will be appreciated by those skilled in the art that a pair of guides 1 may be fitted on a pair of fishing lines 30 which extend from fishing rods 31 on opposite sides of a boat 74. The guides 1 may be placed at any desired distance from the respective fishing lures 44 on the fishing lines 30. During trolling of the boat 74, the guides 1 pull the fishing lures 44 along curved guide travel paths 48 away from the midline 75 of the boat 74. This prevents the fishing lines 30 of the respective fishing rods 31 from becoming inadvertently tangled during retrieval of the fishing lures 44.

While various illustrative embodiments of the disclosure have been described above, it will be recognized and understood that various modifications can be made in the disclosure and the appended claims are intended to cover all such modifications which may fall within the spirit and scope of the embodiments of the disclosure.

What is claimed is:

1. A directional guide for a fishing lure, comprising:
a guide body having a first guide body section and a second guide body section generally complementary in size and shape to said first guide body section, said first guide body section and said second guide body section adapted for attachment to a fishing line; and
at least one beveled guide body end on said guide body.

2. The directional guide of claim 1 wherein said guide body is generally semicircular and each of said first guide body section and said second guide body section is generally half-semicircular.

3. The directional guide of claim 1 wherein said at least one beveled guide body end comprises a pair of beveled guide body ends.

4. The directional guide of claim 1 further comprising at least one weight carried by said guide body.

5. The directional guide of claim 1 further comprising at least one fishing line retention spring extending between said first guide body section and said second guide body section.

6. The directional guide of claim 5 wherein said at least one fishing line retention spring comprises a pair of spaced-apart fishing line retention springs.

7. The directional guide of claim 1 further comprising a first elastomeric glue strip carried by said first guide body section and a second elastomeric glue strip carried by said second guide body section and engaging said first elastomeric glue strip.

8. The directional guide of claim 1 further comprising a first magnet carried by said first guide body section and a second magnet carried by said second guide body section and engaging said first magnet.

9. A directional guide for a fishing lure, comprising:
a guide body adapted for attachment to a fishing line and having a first guide body section, a second guide body section generally complementary in size and shape to said first guide body section and a fishing line gap between said first guide body section and said second guide body section; and
at least one structurally unobstructed beveled guide body end on said guide body.

10. The directional guide of claim 9 wherein said first guide body section comprises a first generally planar interior surface and said second guide body section comprises a second generally planar interior surface generally parallel, spaced-apart and adjacent to said first generally planar interior surface.

11. The directional guide of claim 10 further comprising at least one fishing line retention spring extending between said first generally planar interior surface and said second generally planar interior surface.

12. The directional guide of claim 11 wherein said at least one fishing line retention spring comprises a pair of spaced-apart fishing line retention springs.

13. The directional guide of claim 10 further comprising a first elastomeric glue strip carried by said first generally planar interior surface and a second elastomeric glue strip carried by said second generally planar interior surface and engaging said first elastomeric glue strip.

14. The directional guide of claim 10 further comprising a first magnet carried by said first generally planar interior surface and a second magnet carried by said second generally planar interior surface and engaging said first magnet.

15. The directional guide of claim 9 further comprising at least one weight carried by at least one of said first guide body section and said second guide body section.

16. A fishing lure assembly, comprising:
a fishing line;
a directional guide having a guide body carried by said fishing line and at least one beveled guide body end on said guide body; and
a fishing lure carried by said fishing line in trailing relationship to said directional guide.

17. The fishing lure assembly of claim 16 wherein said directional guide comprises a first guide body section and a second guide body section generally complementary in size and shape to said first guide body section, and wherein said fishing line is sandwiched between said first guide body section and said second guide body section.

18. The fishing lure assembly of claim 17 further comprising at least one spring extending between said first guide body section and said second guide body section and wherein said fishing line is retained by said at least one spring.

19. The fishing lure assembly of claim 17 further comprising a first elastomeric glue strip carried by said first guide body section and a second elastomeric glue strip carried by said second guide body section and engaging said first elastomeric glue strip.

20. The directional guide of claim 17 further comprising a first magnet carried by said first guide body section and a second magnet carried by said second guide body section and engaging said first magnet.
